(19) United States
(12) Patent Application Publication
(10) Pub. No.: US 2008/0148280 A1
(43) Pub. Date: Jun. 19, 2008

(54) APPARATUS, SYSTEM, AND METHOD FOR AUTONOMICALLY MANAGING MULTIPLE QUEUES

(76) Inventors: Joseph W. Stillwell, Kerrville, TX (US); Judy Y. Tse, San Jose, CA (US)

Correspondence Address: Kunzler & McKenzie, 8 EAST BROADWAY, SUITE 600, SALT LAKE CITY, UT, 84111, US

(21) Appl. No.: 11/610,321

(22) Filed: Dec. 13, 2006

(51) Int. Cl. G06F 3/00

(52) U.S. Cl. 719/314

(57) ABSTRACT

An apparatus, system, and method are disclosed for autonomically managing multiple queues in a data processing system. A receiver module receives a message that specifies a computing task. A time stamp module appends a time stamp recording a time the message is received to the message. An assignment module assigns the message to a local queue if the local queue has less than a specified threshold number of messages else assign the message to a global queue. A processor module processes a specified initial number of next messages from the local queue and process a next message from the local queue if a time stamp of the local queue next message is less than a time stamp of a last message processed from the global queue else processes the next message from the global queue.

### BACKGROUND OF THE INVENTION

1. Field of the Invention

This invention relates to queues and more particularly relates to autonomically managing multiple queues.

2. Description of the Related Art

Data processing systems often employ multiple data processing devices (DPD) to share a plurality of discrete computational tasks. The discrete computational tasks may be part of a larger computational operation such as a transaction processing operation. The computation operation is divided into the discrete computational tasks so that the multiple DPD may each concurrently process a portion of the operation.

For example, each DPD of a data processing system may receive a discrete computational task, process the task, and receive another task. By dividing computational tasks, the data processing system may manage significantly larger computational operations.

As used herein, computational tasks are referred to as messages. The data processing system may receive messages from one or more clients, such as computer workstations, servers, mainframe computers and the like. The DPD are referred to herein as nodes. A node may be a server, a blade server, a mainframe computer, a computer workstation, and a processor of a multi-processor computer.

A user of a computer workstation may communicate a transaction message over a network to a server node. The node may process the message, and then receive and process another message. Messages may be received faster than the messages can be processed by the nodes. As a result, messages are often organized in a local queue for each node. Unfortunately, the local queues of some nodes may fill with more rapidly with messages than other local queues. For example, a first node may receive more messages than a second node so that the local queue of the first node may fill with ever more messages. As a result, some messages are processed later than other contemporaneous messages.

A global queue has been used to share messages between nodes. The global queue may receive messages in place of local queues with too many messages. Nodes may then periodically process messages from the global queue. Thus the global queue may prevent local queues from filling with an excessive number of messages.

Unfortunately, with global queues, some messages may be processed significantly earlier than other messages. For example, a first message received at a local queue may be processed after a second subsequent message received at the global queue. As a result, messages may be processed significantly out of order.

From the foregoing discussion, there is a need for an apparatus, system, and method that autonomically manage multiple queues. Beneficially, such an apparatus, system, and method would normalize processing times for messages received in different queues.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a distributed computing environment;

FIG. 2 is a schematic block diagram illustrating one embodiment of message queues of the present invention;

FIG. 3 is a schematic block diagram illustrating one embodiment depicting a queue management apparatus according to the present invention;

FIG. 4 is a schematic flow chart diagram illustrating one embodiment of a multiple message queuing method of the present invention; and

FIG. 5 is a schematic flow chart diagram illustrating one embodiment of a multiple message processing method of the present invention.

### DETAILED DESCRIPTION OF THE INVENTION

Many of the functional units described in this specification have been labeled as modules, in order to more particularly emphasize their implementation independence. Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

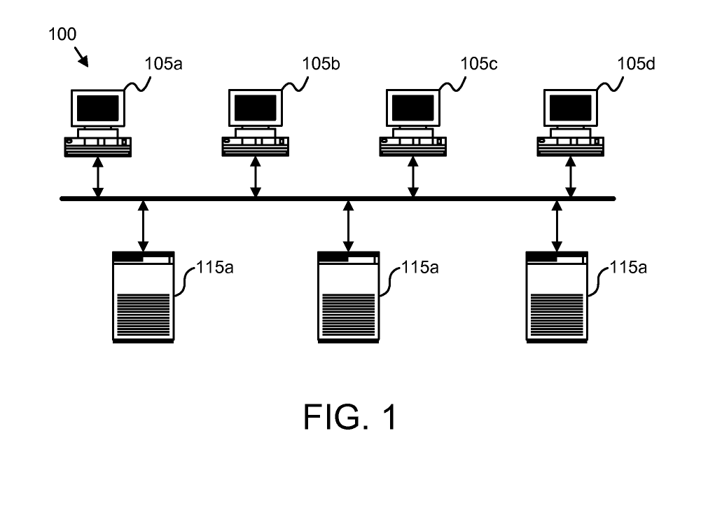

FIG. 1 depicts a distributed computing environment 100. The distributed computing environment 100 comprises one or more clients 105 and one or more nodes 115. In one embodiment, the clients 105 communicate tasks to the nodes 115. The nodes 115 are shown as servers. However, the nodes may be mainframe computers, blade servers, processors of a server, or the like.

In one embodiment, the environment 100 is a Parallel Sysplex environment produced by International Business Machines Corporation (IBM) of Armonk, N.Y. One of skill in the art will recognize that the environment 100 may also be configured as other distributed computing environments.

The tasks are referred to herein as messages. Each node 115 maybe assigned one or more messages from one or more clients 105. As will be more fully described hereafter, the present invention autonomically manages multiple queues for the distributed computing environment 110 so that messages may be more closely processed in the order that the messages are received by the nodes 115.

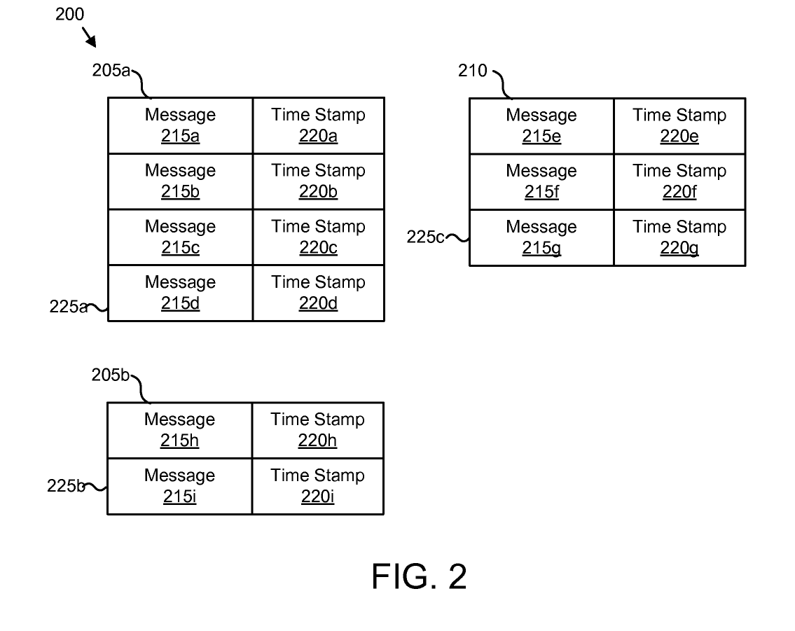

FIG. 2 is a schematic block diagram illustrating one embodiment of message queues 200 of the present invention. The description of the message queues 200 refers to elements of FIG. 1, like numbers referring to like elements. The message queues 200 include one or local queues 205 and a global queue 210. Each local queue 205 and the global queue 210 may include one or more messages 215 and a time stamp 220 associated with each message 215. Each time stamp 220 records when the corresponding message 215 is received in the local queue 205 and/or the global queue 210.

In the distributed processing environment 100, each node 115 may employ a local queue 205 to hold each message 215 received from a client 105. For simplicity, two local queues 205 are shown. However, one or skill in the art will recognize that each node 115 may have one or more local queues 205. In a certain embodiment, the global queue 210 may reside on one of the nodes 115.

An application or process executing on a client 105 may communicate a message 215 to another application and/or software process executing on a node 115 in the environment 100. Many inter-application and/or inter-process exchanges are performed using a messaging technique commonly referred to as message queuing. In message queuing, a client software process passes a message 215 to request processing by a node software process. The messages 215 are queued in the local queues 205 to await processing. The global queue 210 may be used to balance the execution of messages 215 so that local queues 205 do not fill with too many messages as will be described hereafter.

The local queue 205 and the global queue 210 are configured as first-in-first-out queues. A message 215 residing in a queue 205, 210 the longest time is a next message 225. For example, a fourth message 215d of a first local queue 205a is the next message 225a for the first local queue 205a if the fourth message 215d resides on the first local queue 205a longer than a first, a second, and a third message 215a-c.

It is often advantageous that the messages 215 are processed in nearly the order in which the messages 215 are received by the nodes 115. Unfortunately, over time disparities in numbers of messages 215 in local queues 205 and global queue 210 may cause messages 215 to be executed significantly out of order.

In addition, if too much time is spent processing local queue messages 215, those messages 215 on the global queue 210 may sit unserviced for an extended period of time. If too much time is spent processing the global queue messages 215, then the local queues fill with too many messages. This will cost additional overhead and increase the probability that messages 215 will be processed out of sequence with respect to their arrival time. The present invention autonomically manages local queues 205 and the global queue 210 based on input message arrival times of messages at the local and global queues 205, 210 to process messages 215 more nearly in the order in which the messages 215 are received.

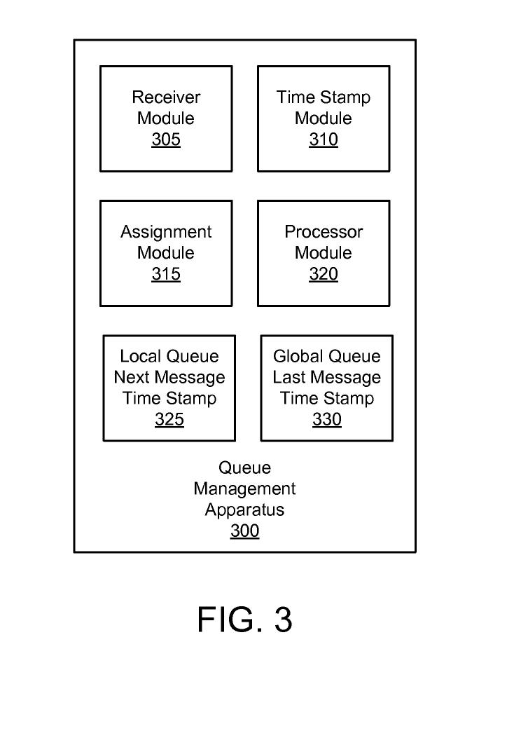

FIG. 3 depicts one embodiment of a queue management apparatus 300 of the present invention. The apparatus 300 includes a receiver module 305, a time stamp module 310, an assignment module 315, a processor module 320, a local queue next message time stamp 325, and a global queue last message time stamp 330. The description of the apparatus 300 refers to elements of FIGS. 1-2, like numbers referring to like elements.

The processor module 320 may embodied in a node 115 and may execute one or more software processes. One or skill in the art will recognize that each node 115 may have one or more processor modules 320. In one embodiment, the receiver module 205, time stamp module 310, and assignment module 315 may be embodied in one or more computer program products such as software processes executing on the processor module 320.

The receiver module 305 is configured to receive a message 215 that specifies a computing task. For example, the receiver module 305 may receive a message 215 from a client 105 and store the message 215 in the first local queue 205a of a first node 115a. The receiver module 305 may be configured as a software port. In addition, the receiver module 305 may include a buffer as is well known to those of skill in the art.

The time stamp module 310 appends a time stamp 220 recording a time the message 215 is received. In one embodiment, the time stamp module 310 calls a current time software process of a node 115 operating system and receives a current time from the operating system to append to the message 215.

The assignment module 315 assigns the message 215 to a local queue 205 if the local queue 205 has less than a specified threshold number of messages 205. For example, if the specified threshold is four (4) messages, the assignment module 315 may assign the message 215 to the first local queue 205 if the first local queue 215a has less than four (4) messages. If the local queue 205 does not have less than the specified threshold number of messages 215, the assignment module 315 assigns the message 215 to the global queue 210.

Each processor module 320 maintains a global queue last message time stamp 330. The global queue last message time stamp 330 records the time stamp 220 corresponding to the last message 215 from the global queue 205 processed by any processor module 320. In one embodiment, each processor module 320 also maintains the local queue next message time stamp 325 with the value of the time stamp 220 of the next message 225 in the local queue 205. The global queue last message time stamp 330 and the local queue next message time stamp 325 may be configured as memory addresses, processor registers, and the like.

Each processor module 320 processes messages 215 from each processor module's own local queue 205. In addition, each processor module 320 may process messages 215 from the global queue 210. The processor module 320 processes a next message 225 from the local queue 205 if a time stamp 220 of the local queue next message 225, such is stored in the local queue next message time stamp 325, is less than a time stamp 220 of a last message processed from the global queue 210. The global queue last message time stamp 330 stores the time stamp 220 of a last message processed from the global queue 210. If the time stamp 220 of the local queue next message 225 is not less than the global queue last message time stamp 330, the processor module 320 processes the next message 225 from the global queue 210.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

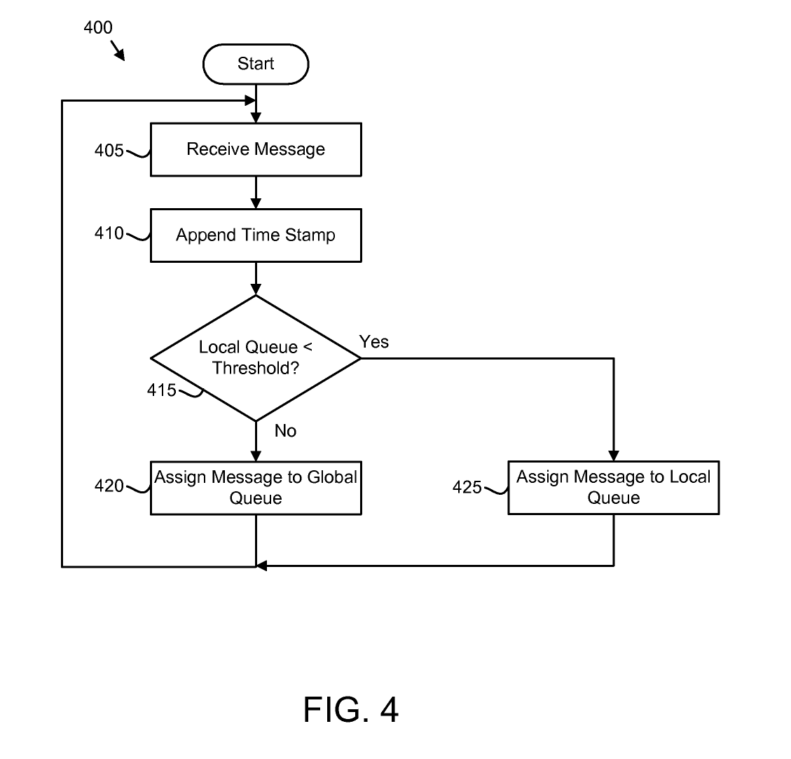

FIG. 4 is a schematic flow chart diagram illustrating one embodiment of a multiple message queuing method 400 in accordance with the present invention. The method 400 substantially includes the steps to carry out the functions presented above with respect to the operation of the described apparatus 300 and environment 100 of FIGS. 1-3. In one embodiment, the method 400 is implemented with a computer program product comprising a computer readable medium having a computer readable program. The computer readable program is executed by a computer such as a node 115 and/or a processor module 320 of a node 115.

The method 400 begins, and the receiver module 305 receives 405 a message 215 that specifies a computing task. In one embodiment, a client 105 communicates the message to a node 115. The receiver module 305 executing on the node 305 may identify the message 215 and communicate the message 215 to the time stamp module 310. The receiver module 305 may communicate the message 215 by passing the message in a function call to the time stamp module 310.

The time stamp module 310 appends 410 a time stamp 220 recording a time the message 215 is received. In one embodiment, the time stamp module 310 retrieves a time for the time stamp 220 from a node clock. Alternatively, the time stamp module 310 may retrieve the time from a common clock for the environment 100.

The assignment module 315 determines if the local queue 205 has less than the specified threshold number of messages 215. In one embodiment, the specified threshold number is the larger of five (5) and twenty-five to one hundred percent (25-100%) of a number of active instances of processor modules. For example, if the environment 100 included eight (8) nodes 115 each with a processor module 320, the specified threshold number of messages 215 may be selected from the range of five to eight (5-8) messages 215.

Alternatively, if the environment 100 included fifty (50) nodes 115 each with two processor modules 320, the specified number of messages 215 is selected from the range of twenty-five to one hundred (25-100) messages 215.

If the local queue 205 has less than the specified threshold number of messages 215, the assignment module 215 assigns 425 the message 215 to the local queue 205. If the local queue 205 does not have less than the specified threshold number of messages 215, the assignment module 215 assigns 420 the message 215 to the global queue 210.

In one embodiment, the assignment module 315 assigns 425 the message 215 to a local queue 205 or assigns 420 the message 215 to the global queue 210 by writing a pointer to a last-in message 215 of the queue 205, 210. For example, the assignment module 315 may assign 420 a fifth message 215e to the global queue 210 by writing a pointer to the fifth message 215e at a data structure of a sixth message 215f of the global queue 210, wherein the sixth message 215f is the last-in message 215. The fifth message 215e becomes the last-in message so that the assignment module 315 will write a pointer to a subsequently received message 215 to a data structure of the sixth message 215f.

The method 400 mitigates against too many messages 215 being placed in a local queue 205 for a processor module 320 of a node 115. When the messages 215 in a local queue 205 exceed the specified threshold number of messages 215, messages 215 are assigned 420 to the global queue 210, and from the global queue 210 allocated among the processor modules 320 of the environment 100.

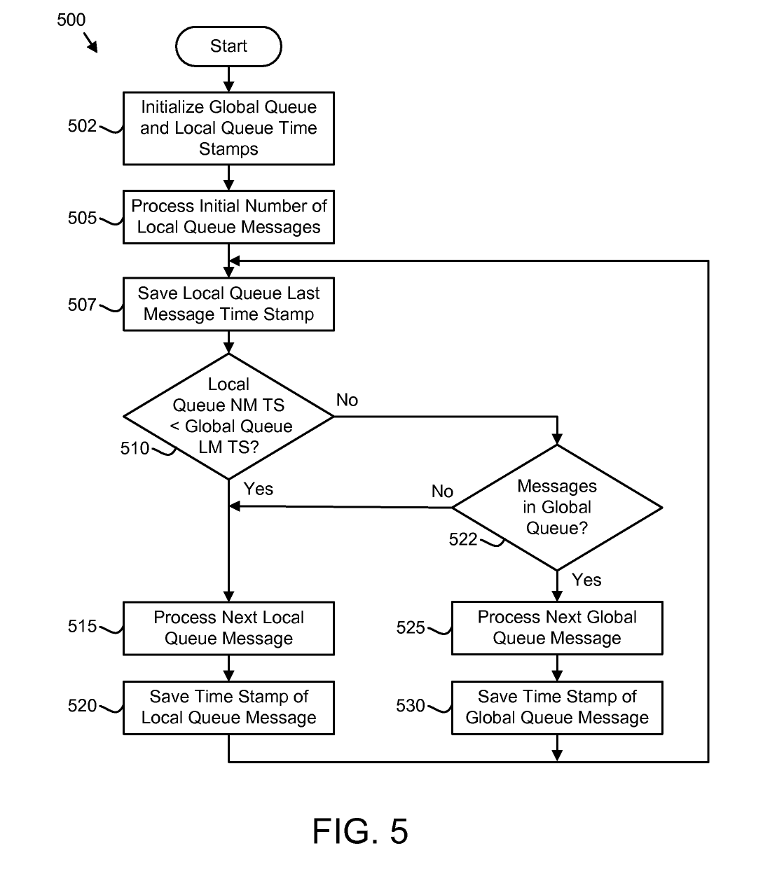

FIG. 5 is a schematic flow chart diagram illustrating one embodiment of a multiple message processing method 500 in accordance with the present invention. The method 500 substantially includes the steps to carry out the functions presented above with respect to the operation of the described apparatus 300 and environment 100 of FIGS. 1-3. In one embodiment, the method 500 is implemented with a computer program product comprising a computer readable medium having a computer readable program. The computer readable program is executed by a computer such as a node 115 and/or a processor module 320 of a node 115.

The method 500 begins and in one embodiment, the processor module 320 initializes 502 the time stamps 220, 330 of the local queue 205 and the global queue 210. In a certain embodiment, the processor module 320 initializes 502 the global queue last message time stamp 330 to a current time.

The processor module 320 processes 505 an initial number of messages 215 from the processor module's local queue 205. In one embodiment, the initial number is in the range of four to twenty (4-20) messages 215. The time stamp module 310 may save 507 the time stamp of the next message 225 of the local queue 205 to the local queue next time stamp 325.

The processor module 320 may determine 510 if the local queue next message time stamp 325 is less than the global queue last message time stamp 330. If the local queue next message time stamp 325 is less than the global queue last message time stamp 330, the processor module 320 processes 515 the next message 225 from the local queue 205 of the processor module 320. The processor module 320 may process 515 the next message 225 by removing the next message 225 from the local queue 205. For example, the processor module may remove a fourth message 215d from the first local queue 205a, and make a third message 215c the subsequent next message. In addition, the time stamp module 310 saves the time stamp 220 of the subsequent local queue message and the processor module 320 determines 510 if the time stamp 220 of the subsequent local queue next message 225 is less than the global queue last message time stamp 330.

If the local queue next message time stamp 325 is not less than the global queue last message time stamp 330, the processor module 320 processes 515 the next message 225c from the global queue 525. The processor module 320 may process 515 the next message 225c by removing the next message 225 from the global queue 210. For example, the processor module may remove a seventh message 215g from the global queue 210, and make the sixth message 215f the subsequent next message. In addition, the time stamp module 310 saves the time stamp 220 of the processed global queue message 215 to the global queue last message time stamp 330 and the time stamp module 310 may save 507 the time stamp of the subsequent next message of the local queue 205 to the local queue next time stamp 325.

The method 500 autonomically manages the multiple queues 205, 210 for the processor modules 320 of the nodes 115, mitigating against any processor module 320 spending too much time processing messages from the processor module's local queue 205 and/or the global queue 210. In addition, the method 500 allows messages 215 to be processed more nearly in the in order in which the messages 215 are received.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to autonomically manage multiple queues, the apparatus: comprising:
a receiver module configured to receive a message that specifies a computing task;
a time stamp module configured to append a time stamp recording a time the message is received to the message;
an assignment module configured to assign the message to a local queue if the local queue has less than a specified threshold number of messages else assign the message to a global queue, wherein the local queue and the global queue are configured as first-in-first-out queues and a message residing in a queue the longest time is a next message;
a processor module of a plurality of processor modules configured to process a specified initial number of next messages from the local queue and process a next message from the local queue if a time stamp of the local queue next message is less than a time stamp of a last message processed from the global queue else process the next message from the global queue, wherein the plurality of processor modules each maintains the local queue last message time stamp and the global queue last message time stamp and each processor module processes messages from each processor module's own local queue, and wherein each processor module may process messages from the global queue.

2. The apparatus of claim 1, wherein the processor module processes all messages in the local queue and the global queue in a time sequence based on time stamps of messages, the time sequence ordered from earliest to latest.

3. The apparatus of claim 1, wherein the specified threshold number is the larger of five and twenty-five percent of a number of active instances of processor modules.

4. The apparatus of claim 1, wherein the processor module is executing in an IBM Parallel Sysplex® environment under an IBM z/OS® operating system.

5. A computer program product comprising a computer useable medium having a computer readable program, wherein the computer readable program when executed on a computer causes the computer to:
receive a message that specifies a computing task;
append a time stamp recording a time the message is received to the message;
assign the message to a local queue of a plurality of local queues if the local queue has less than a specified threshold number of messages else assign the message to a global queue, wherein the local queue and the global queue are configured as first-in-first-out queues and a message residing in a queue the longest time is a next message;
process a specified initial number of next messages from the local queue; and
process a next message from the local queue if a time stamp of the local queue next message is less than a time stamp of a last message processed from the global queue else process the next message from the global queue.

6. The computer program product of claim 5, wherein the computer readable code is further configured to cause the computer to process all messages in the local queue and the global queue in a time sequence based on time stamps of messages, the time sequence ordered from earliest to latest.

7. The computer program product of claim 5, wherein the specified threshold number is the larger of five and twenty-five to one hundred percent of a number of active instances of processor modules.

8. The computer program product of claim 5, wherein a plurality of nodes execute the computer readable program and wherein there is a local queue for each node executing at least one instance of a processor module.

9. The computer program product of claim 5, wherein the computer readable program is executing in an IBM Parallel Sysplex® environment under an IBM z/OS® operating system.
